(19) United States
(12) Patent Application Publication
(10) Pub. No.: US 2012/0128924 A1
(43) Pub. Date: May 24, 2012

(54) RECYCLED POLY(TRIMETHYLENE TEREPHTHALATE) AND PROCESSES

(75) Inventors: Geraldine M. Lenges, Wilmington, DE (US); Dennis Gerard Madeleine, Wilmington, DE (US); Kalika Ranjan Samant, Hockessin, DE (US)

(73) Assignee: E. I. DU PONT DE NEMOURS AND COMPANY, Wilmington, DE (US)

(21) Appl. No.: 13/110,243

(22) Filed: May 18, 2011

Related U.S. Application Data
(60) Provisional application No. 61/345,698, filed on May 18, 2010.

(51) Int. Cl. B32B 33/00; B29C 47/00; C08G 63/183

(52) U.S. Cl. 428/97; 528/308.6; 264/176.1

(57) ABSTRACT

The present invention relates to recycled poly(trimethylene terephthalate), and products and processes using the recycled poly(trimethylene terephthalate).

### FIELD OF THE INVENTION

The present invention relates to recycled poly(trimethylene terephthalate), and products and processes using the recycled poly(trimethylene terephthalate).

### BACKGROUND

Frequently, the presence of impurities in polymers, including recycled content, can disrupt fiber micro-structure, leading to difficulties in drawing the fibers. This can lead to lower tenacity, which can affect fibrillation and texture retention. Deleterious effects on other physical properties, such as elongation to break, have been observed as well.

U.S. Patent Publication No. 2008/0113146 discloses a method for reclaiming polymer from a carpet, for reuse in making carpet. The method includes contacting carpet with a terpene solvent solution to dissolve portions of the carpet, leaving the fiber. The terpene solvent must then be separated from the desired carpet fibers. While the terpene may be able to be reclaimed for further use, the handling and use of VOCs such as terpenes are still critical in the process.

A need remains for methods for producing fibers, particularly carpet fibers, from materials containing recycled content, without sacrificing desirable physical properties in products made from the fibers. It is particularly desirable to provide carpets made from fibers having recycled content while maintaining durability and esthetic properties such as those obtained in carpets made from poly(trimethylene terephthalate). It would be further advantageous if such fibers having recycled content can be produced with minimal or no use of volatile organic compounds (VOCs).

### SUMMARY OF THE INVENTION

One aspect of the present invention is a fiber containing from 0.1 to 99.9% by weight recycled poly(trimethylene terephthalate), based on the total weight of the fiber, and having a tenacity of at least 1.5 g/denier.

Another aspect of the present invention is a fiber containing from 0.1 to 99.9% by weight recycled poly(trimethylene terephthalate), based on the total weight of the fiber, and having an elongation at break of 65% or less.

A further aspect of the present invention is a process for making a fiber containing from 0.1 to 99.9 weight % recycled poly(trimethylene terephthalate), based on the total weight of the fiber, comprising: providing yarns containing recycled poly(trimethylene terephthalate), melt-pelletizing the yarns, combining the recycled poly(trimethylene terephthalate) with virgin poly(trimethylene terephthalate) to form a blend containing 0.1 to 99.9 weight % recycled poly(trimethylene terephthalate), and spinning the blend to form a fiber.

Another aspect of the present invention is a process for making fiber containing 0.1 to 99.9 weight % of recycled poly(trimethylene terephthalate), based on the total weight of the fiber, comprising: providing carpet comprising a backing and poly(trimethylene terephthalate) carpet face fiber; separating the poly(trimethylene terephthalate) carpet face fiber from the backing; melt-pelletizing the fiber to form recycled poly(trimethylene terephthalate) pellets; providing virgin poly(trimethylene terephthalate) pellets; and feeding the recycled poly(trimethylene terephthalate) pellets and the virgin poly(trimethylene terephthalate) pellets to a spinning machine to form a fiber containing 0.1 to 99.9 weight % recycled poly(trimethylene terephthalate) fiber.

### DETAILED DESCRIPTION

Provided are poly(trimethylene terephthalate) fiber, and carpet made from the fiber, that contain recycled poly(trimethylene terephthalate). It has been surprisingly found that desirable mechanical properties for yarns and articles made from the yarns can be obtained in poly(trimethylene terephthalate) fiber containing recycled poly(trimethylene terephthalate) (PTT). More particularly, the present inventors have found that properties similar or equivalent to those obtained in fibers made from virgin PTT can be obtained with recycled PTT.

By “virgin” PTT as used herein is meant PTT that does not contain any recycled PTT. Recycled PTT includes pre-consumer and post-consumer recycled PTT. Post-consumer recycled PTT may be referred to, for example, using a shorthand term such as “post-consumer PTT”. Post-consumer PTT preferably contains at least 25%, 50%, or 45% PTT that has been recycled after use in a consumer product.

In some embodiments of the present invention, a fiber contains from 0.1 to 99.9% by weight recycled PTT, based on the total weight of the fiber, and having a tenacity of at least 1.5 g/denier. The fiber is preferably substantially all PTT, i.e. at least 85%, 95%, 99% or 100% PTT, of which 0.1 to 99.9% can be recycled PTT.

In some embodiments, the recycled PTT content in the fiber is 0.5% or greater, and the recycled PTT content can be 1%, 5%, 10%, 20%, 25%, 30%, 40%, 50%, 60%, 70%, 80%, 90% by weight or higher, based on the total weight of the fiber.

In some preferred embodiments the tenacity is 2 g/denier or greater, and in some preferred embodiments the tenacity is 2.5 g/denier or greater.

In some preferred embodiments, the elongation at break is 55%, or less than 55%.

In some embodiments, a PTT yarn is made from the fiber. The yarns are particularly suitable for making carpet containing from 0.1 to 99 weight % recycled PTT yarn.

Also provided herein is a process for making a fiber containing from 0.1 to 99 weight % recycled PTT, comprising: providing yarns containing recycled PTT, melt-pelletizing the yarns, combining the recycled PTT with virgin PTT to form a blend containing 0.1 to 99.9 weight % recycled PTT, and spinning the blend to form a fiber.

Some embodiments of the present invention provide processes for making fiber containing 0.1 to 99.9 weight % of recycled PTT. In a preferred embodiment, the process comprises: providing carpet comprising a backing and poly(trimethylene terephthalate) carpet face fiber; separating the poly(trimethylene terephthalate) carpet face fiber from the backing; melt-pelletizing the fiber to form recycled poly(trimethylene terephthalate) pellets; providing virgin poly(trimethylene terephthalate) pellets; and feeding the recycled poly(trimethylene terephthalate) pellets and the virgin poly(trimethylene terephthalate) pellets to a spinning machine to form a fiber containing 0.1 to 99.9 weight % recycled poly(trimethylene terephthalate) fiber.

The present invention provides unexpected advantages in that the processes disclosed herein allow the formation of a fiber with recycled content that maintains properties such as tenacity and elongation that are comparable to, and, in preferred embodiments, indistinguishable from, those properties when measured on fibers containing no recycled content. The recycled content can be as low as 0.1 weight % or as high as 99.9 weight %. In particular, it has been found that desirable physical properties for carpet can be maintained without implementing a complicated reclamation process, in comparison to conventional methods that can require washing, mechanical cleaning, and/or the use of VOCs such as terpenes. According to embodiments of the present invention, reclamation of recycled PTT can be obtained by simple steps including shearing and melt-pelletizing.

In some preferred embodiments, the PTT being reclaimed and recycled and/or virgin PTT with which the PTT is combined are bio-derived. By “bio-derived” is meant that the polymer is prepared from materials derived from biological sources. For example, the PTT can be prepared from 1,3-propanediol that has been produced in a biological method such as fermentation. One such process is disclosed in U.S. Pat. No. 6,514,733. As disclosed in U.S. Pat. No. 6,428,767, biosourced 1,3-propanediol and polymers derived therefrom can be distinguished from their petrochemical derived counterparts on the basis of ¹⁴C (fm) and dual carbon-isotopic fingerprinting. The use of bio-derived starting materials in virgin PTT, and preferably also in the PTT in the carpet being used for the recycled polymer, provides a sustainable and more environmentally-friendly consumer product than processes using only petroleum-derived materials. Thus, in preferred embodiments, the virgin PTT and/or the recycled PTT are bio-derived.

### EXAMPLES

Poly(trimethylene terephthalate) (Sorona® PTT) carpet was sheared. The fiber properties were measured (% elongation, tenacity, etc.) relative to a 100% virgin poly(trimethylene terephthalate) fiber spun under the same conditions. Results obtained on the virgin PTT are listed as “Control” measurements in the tables below.

### Extrusion and Pelletizing

Broadloom carpets containing poly(trimethylene terephthalate) face-fiber were sheared. The face fiber was dried at 120° C. for 16-hours in a vacuum oven. The polymer fiber was melt-pelletized, blended with virgin poly(trimethylene terephthalate) and spun into fiber using standard melt-spinning equipment (30-mm Werner-Pfleiderer (ZSK-30) twin-screw extruder with electrically heated barrels, once-through cooling water and vacuum ports on barrel-5 and barrel-8.)

### Press Spinning

The poly(trimethylene terephthalate) resin was press-spun through a filter pack (2×50-mesh, 3×200-mesh) at 500 m/min. and 1000 m/min. to evaluate fiber spinning. (Table 1, Example-1 and Example-2).

TABLE 1

| | Post-Consumer | | | |
|---|---|---|---|---|
| | Sorona ® PTT | Zone 2 Temp. | Spin Temp. | Wind-Up |
| Example | (wt %) | deg C. | deg C. | Speed |
| Example-1 | 100 | 260 | 265 | 500 |
| Example-2 | 100 | 260 | 265 | 1000 |

### Melt Spinning

Virgin PTT and recycled PTT were dried at 120° C. for 16-hours in a vacuum oven. Virgin PTT resin was combined with the recycled PTT resin in the ratios listed in Table 2. The virgin poly(trimethylene terephthalate) resin and recycled PTT resin blends were spun into 200-denier/20-dpf (denier-per-filament) fiber using standard melt-spinning equipment.

TABLE 2

| | Post-Consumer | | Feed-Roll | Draw | Wind-Up |
|---|---|---|---|---|---|
| | Sorona ® PTT | Draw | Temp. | Temp. | Speed |
| Examples | (wt %) | Ratio | (deg C.) | (deg C.) | (m/min.) |
| Control-1 | 0 | 2.6 | 60 | 155 | 2995 |
| Control-2 | 0 | 2.8 | 60 | 155 | 2995 |
| Control-3 | 0 | 3.0 | 60 | 155 | 2990 |
| Control-4 | 0 | 3.2 | 60 | 155 | 2990 |
| Example-3 | 5 | 3.2 | 60 | 155 | 2995 |
| Example-4 | 5 | 3.0 | 60 | 155 | 2995 |
| Example-5 | 5 | 2.8 | 60 | 155 | 2995 |
| Example-6 | 5 | 2.6 | 60 | 155 | 2995 |
| Example-7 | 10 | 2.8 | 60 | 155 | 2995 |

### Fiber Analysis

The fiber properties were measured relative to 100% virgin poly(trimethylene terephthalate) fiber spun under the same conditions. Tenacity (grams/denier) and elongation at break (%) were measured using a Textechno Statimat ME textile tensile testing machine (load cell: 100 N, gauge length: 10 in., test speed: 6 in./min, threshold: 1.0% of 100 N, pretension: 0.50 cN/tex, drop of force: 90%). The data is summarized in Table 3. No significant deleterious effect on fiber properties as measured by elongation at break and tenacity was observed with the addition of recycled poly(trimethylene terephthalate).

TABLE 3

| | Post-Consumer | | Elongation | |
|---|---|---|---|---|
| | Sorona ® PTT | Draw | @ Break | Tenacity |
| Examples | (wt %) | Ratio | (%) | (g/den) |
| Control-1 | 0 | 2.6 | 42.62 | 3.09 |
| Control-2 | 0 | 2.8 | 42.43 | 3.20 |
| Control-3 | 0 | 3.0 | 45.71 | 3.06 |
| Control-4 | 0 | 3.2 | 37.80 | 3.34 |
| Example-3 | 5 | 3.2 | 39.31 | 3.18 |
| Example-4 | 5 | 3.0 | 37.98 | 3.17 |
| Example-5 | 5 | 2.8 | 44.30 | 3.10 |
| Example-6 | 5 | 2.6 | 42.51 | 2.87 |
| Example-7 | 10 | 2.8 | 37.39 | 2.76 |

The following summarizes the results in Tables 2 and 3, as a comparison between a Control measurement and an Example measurement:
Control 1 /Example 6 (From Control 1 to Example 6, elongation the same, tenacity drops slightly)
Control 2/Example 5 (elongation comparable, tenacity about the same)
Control 2/Example 7 (elongation lower/better, tenacity is lower)
Control 3/Example 4 (elongation lower/better, tenacity slightly higher/better)
Control 4/Example 3 (elongation comparable, tenacity about the same)

It is expected based on the results observed according to the present invention that an optimized process for higher-purity post-consumer poly(trimethylene terephthalate) could permit incorporations much higher than the 10-wt % exemplified in Table 2 and 3.

The present examples use un-bulked 200-denier yarn. Common commercial carpet yarn deniers range from 1000-denier to 5000-denier. It is expected based on the results observed according to the present invention that an optimized process could produce commercial deniers without a deleterious effect on fiber properties, particularly tenacity and elongation.

The examples herein use 20-dpf yarn. Common commercial carpet yarns range from 15-dpf to 28-dpf. It is expected based on the results observed according to the present invention that an optimized process could produce commercial dpfs without a deleterious effect on fiber properties, particularly tenacity and elongation.

The carpet properties (Vettermann, Hexapod, Stain resistance, etc.) relative to a 100% virgin poly(trimethylene terephthalate) carpet constructed under the same conditions are expected to be similar.
Vs of post-consumer product: All virgin PTT used in the work was 1.02 IV. Goodyear Intrinsic Viscosity of recycled poly(trimethylene terephthalate) after melt pelletizing was 0.875 dL/g.
Moisture content of resin:
DSC data on fiber, pellets and final yarn: This is an analytical method that looks at a melting/heat profile. It can give some information on polymer purity.
Screw Design and detailed conditions for extrusion and pelletizing:-The screw is designed with a mild melt and mix section. There is a partial seal after the melt section to enable vacuum if needed and there is a seal after the mix section to enable full vacuum.
Detailed conditions for melt-spinning:
Fiber cross-section: The fiber used in all examples was spun using a spinneret plate for forming a solid core filament having a longitudinal axis extending therethrough and a three-sided cross section in a plane perpendicular to the longitudinal axis, as described in U.S. patent applications Ser. Nos. 12/338,412 and 12/638036.

1. A fiber containing from 0.1 to 99.9% by weight-recycled poly(trimethylene terephthalate) and having a tenacity of at least 1.5 g/denier.

2. A fiber containing from 0.1 to 99.9% by weight-recycled poly(trimethylene terephthalate) and having an elongation at break of 65% or less

3. A poly(trimethylene terephthalate) yarn containing a fiber of claim 1.

4. A carpet containing from 0.1 to 99 weight % yarns of claim 3, based on the total weight of yarns in the carpet.

5. A process for making a fiber containing from 0.1 to 99.9 weight % recycled poly(trimethylene terephthalate), comprising: providing yarns containing recycled poly(trimethylene terephthalate), melt-pelletizing the yarns, combining the recycled poly(trimethylene terephthalate) with virgin poly(trimethylene terephthalate) to form a blend containing 0.1 to 99.9 weight % recycled poly(trimethylene terephthalate), and spinning the blend to form a fiber.

6. A process for making fiber containing 0.1 to 99.9 weight % of recycled poly(trimethylene terephthalate), comprising: providing carpet comprising a backing and poly(trimethylene terephthalate) carpet face fiber; separating the poly(trimethylene terephthalate) carpet face fiber from the backing; melt-pelletizing the fiber to form recycled poly(trimethylene terephthalate) pellets; providing virgin poly(trimethylene terephthalate) pellets; and feeding the recycled poly(trimethylene terephthalate) pellets and the virgin poly(trimethylene terephthalate) pellets to a spinning machine to form a fiber containing 0.1 to 99.9 weight % recycled poly(trimethylene terephthalate) fiber.

7. The process of claim 5 or claim 6 wherein the virgin poly(trimethylene terephthalate) is bio-derived.

8. The process of claim 5 or claim 6 wherein the recycled poly(trimethylene terephthalate) is bio-derived.

9. The fiber of claim 1 or claim 2 wherein the recycled poly(trimethylene terephthalate) is bio-derived.

10. The fiber of claim or claim 2, wherein the fiber further comprises from 99.9 to 0.1 weight % virgin poly(trimethylene terephthalate).
